(19) United States
(12) Patent Application Publication
(10) Pub. No.: US 2010/0232857 A1
(43) Pub. Date: Sep. 16, 2010

(54) IMAGE FORMING APPARATUS

(75) Inventor: Toru Nakayama, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/694,921

(22) Filed: Jan. 27, 2010

(30) Foreign Application Priority Data
Mar. 12, 2009 (JP) 2009-059880

(51) Int. Cl. G03G 15/00

(52) U.S. Cl. 399/405

(57) ABSTRACT

An embodiment includes an image forming apparatus utilizing internal paper ejection. An embodiment may include a paper ejection tray disposed on the bottom of a paper ejection space. In some embodiments, the paper ejection tray may include a flat portion, a sloping portion, and/or a protruding portion. In an embodiment, the flat portion of the paper ejection tray may extend substantially horizontally by a predetermined distance downstream from a wall on the upstream side in a paper ejection direction. An embodiment may include a sloping portion that slopes upward downstream from the flat portion. In some embodiments, the protruding portion may slope upward from the flat portion to the front of the apparatus, the top of the protruding portion being higher than an operation panel.

### INCORPORATION BY REFERENCE

This application is based upon and claims the benefit of priority from the corresponding Japanese Patent application No. 2009-059880, filed Mar. 12, 2009, the entire contents of which are incorporated herein by reference.

### FIELD OF THE INVENTION

The present invention relates to an image forming apparatus such as a copier, a printer, and/or a facsimile machine, and more specifically, it relates to a system for enhancing removal of paper from a paper ejection tray disposed in an internal paper ejection space.

### BACKGROUND OF THE INVENTION

Some of electrophotographic image forming apparatuses (e.g., copiers) are of an internal paper ejection type. These electrophotographic image forming apparatuses may include an image forming unit, an image reading unit over the image forming unit, and an internal paper ejection space between the image forming unit and the image reading unit. On the bottom of the internal paper ejection space, a paper ejection tray is disposed. In front of the paper ejection tray, an operation panel is disposed. Paper ejected onto the paper ejection tray after the completion of image formation is taken out from the front of the apparatus main body.

An image forming apparatus having such a paper ejection tray can be shown, for example, in FIG. 8. FIG. 8 is an external perspective view of a conventional image forming apparatus. FIG. 9 shows a flat potion, a sloping portion, and an operation panel of the image forming apparatus of FIG. 8 with paper placed on a paper ejection tray as viewed from the X direction of FIG. 8. FIG. 10 shows the flat potion, the sloping portion, and the operation panel of the image forming apparatus of FIG. 8 as viewed from the Y direction of FIG. 8. The same reference numerals will be used to designate the same components as those in FIG. 8, so that the description thereof will be omitted.

As shown in FIG. 8, the image forming apparatus 200 includes: an image reading unit A capable of reading a document; a paper cassette 40 holding paper P; an image forming unit B that forms an image on paper P conveyed from the paper cassette 40 on the basis of image information read in the image reading unit A; an internal paper ejection unit 22 having a paper ejection tray 23; and an ejection roller 51 that ejects paper P on which an image is formed in the image forming unit B onto the paper ejection tray 23.

The paper ejection tray 23 is provided with: a flat portion 61 that extends substantially horizontally and downstream from a back wall 23a on the upstream side in the direction of ejection (direction of the arrow); and a sloping portion 63 that slopes upward from the flat portion 61 downstream in the direction of ejection. As shown in FIG. 9, since the paper ejection tray 23 is provided with the flat portion 61, a space W is defined by the paper P placed on the paper ejection tray 23, the flat portion 61, and the sloping portion 63. Therefore, the user can easily hold the paper P by inserting their hand into the space W.

However, when inserting and pulling out a hand to take out the paper P from the paper ejection tray 23, the hand passes closely over the operation panel 26 as shown in FIG. 10. Depending on the angle at which the hand is inserted and pulled out, the height and posture of the person who takes out the paper P, and the like, the hand may touch the operation buttons 26a of the operation panel 26 when taking out the paper P. Therefore, even if the flat portion 61 is provided, a malfunction may occur when taking out the paper P from the paper ejection tray 23.

As described above, if the paper ejection tray is disposed at the same height as the operation panel or at a position lower than the operation panel, the hand holding paper may touch the operation panel and may cause a malfunction when taking out paper from the paper ejection tray.

To prevent such a malfunction during taking out of paper from the paper ejection tray, a known image forming apparatus includes: a detecting unit that detects an operation to take out paper after the completion of image formation from the paper ejection tray; and a control unit that disables at least part of the operation panel when the detecting unit detects an operation to take out paper after the completion of image formation.

However, since this image forming apparatus requires a detecting unit for detecting insertion of hand, the cost is increased. In addition, depending on the arrangement of the detecting unit, insertion of hand may not be reliably detected, and therefore a malfunction during taking out of paper from the paper ejection tray may not be prevented.

### SUMMARY OF THE INVENTION

Accordingly, it is an object of the present invention to provide an image forming apparatus having a simple configuration that facilitates removal of paper and that ensures a clearance between paper and an operation panel to reduce the likelihood of a malfunction during the removal of paper.

In some embodiments, an image forming apparatus may include a paper feed unit, an image forming unit, an image reading unit, a paper ejection space, a paper ejection tray, and/or an operation panel. For example, an embodiment of an image forming apparatus may include a paper feed unit that feeds paper, an image forming unit that forms an image on paper fed from the paper feed unit, an image reading unit that is disposed over the image forming unit and that reads the image of a document, a paper ejection space that is provided between the image forming unit and the image reading unit and at least the front side of which is open, a paper ejection tray that is disposed on the bottom of the paper ejection space and onto which paper after image formation is ejected, and an operation panel that is disposed in front of the paper ejection tray.

In an embodiment, a paper ejection tray may have a flat portion that extends substantially horizontally by a predetermined distance downstream from a wall on the upstream side in a paper ejection direction. Some embodiments of the paper ejection tray may include a sloping portion that slopes upward from the flat portion downstream in the paper ejection direction. In an embodiment, a paper ejection tray may include a protruding portion that slopes upward from the flat portion to the front, the top of the protruding portion being higher than the operation panel. Some embodiments may include a combination of the features described.

Additional features and advantages are described herein, and will be apparent from the following Detailed Description and the figures.

The above and other objects, features, and advantages of the present invention will be more apparent from the following detailed description of embodiments taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

Various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is an external perspective view of an image forming apparatus according to an embodiment of the present invention;

FIG. 2 is a schematic sectional view showing the internal configuration of the image forming apparatus of this embodiment;

FIG. 3 is an enlarged partial perspective view showing a paper ejection tray of the image forming apparatus of FIG. 1;

FIG. 4 is a plan view of a flat portion, a sloping portion, a protruding portion, and an operation panel of FIG. 3;

FIG. 5 is a front view of the flat portion, the sloping portion, the protruding portion, and the operation panel of FIG. 4 with paper placed on the paper ejection tray;

FIG. 6 is a left side view of the flat portion, the sloping portion, the protruding portion, and the operation panel of FIG. 4;

FIG. 7 shows a modification of the protruding portion of the paper ejection tray used in the image forming apparatus of this embodiment, and FIG. 7 is a left side view of the flat portion, the sloping portion, the protruding portion, and the operation panel of FIG. 4;

FIG. 8 is an external perspective view of a conventional image forming apparatus;

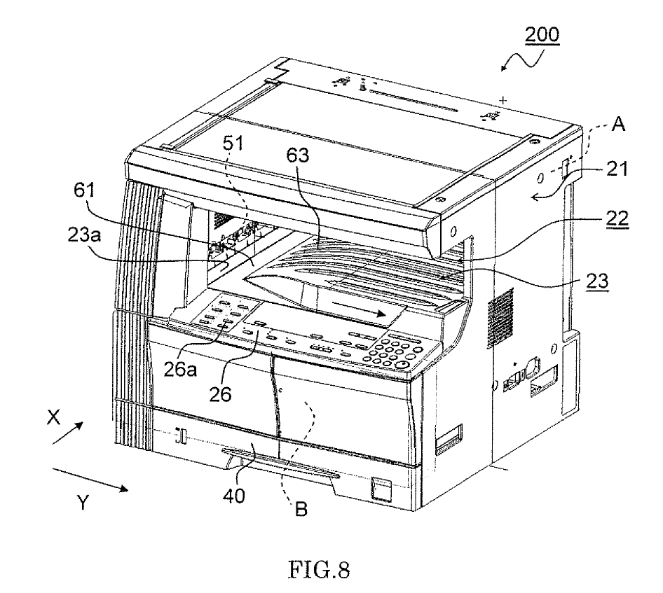

FIG. 9 shows a flat potion, a sloping portion, and an operation panel of the image forming apparatus of FIG. 8 with paper placed on a paper ejection tray as viewed from the X direction of FIG. 8; and

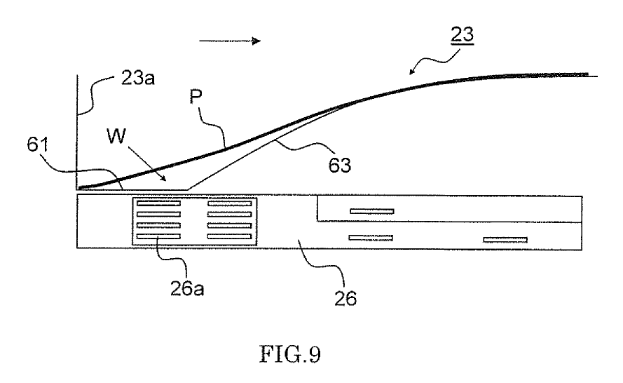

FIG. 10 shows the flat potion, the sloping portion, and the operation panel of the image forming apparatus of FIG. 8 as viewed from the Y direction of FIG. 8.

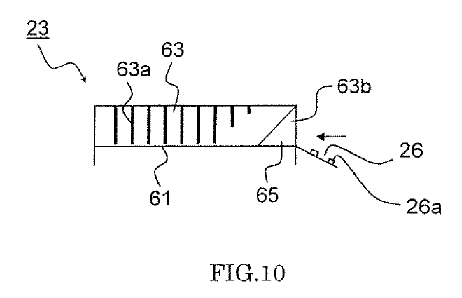

### DETAILED DESCRIPTION OF THE EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents.

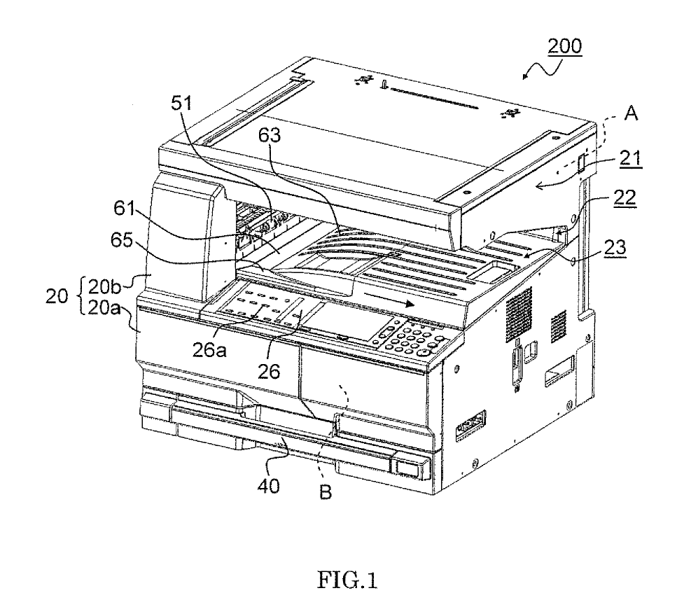

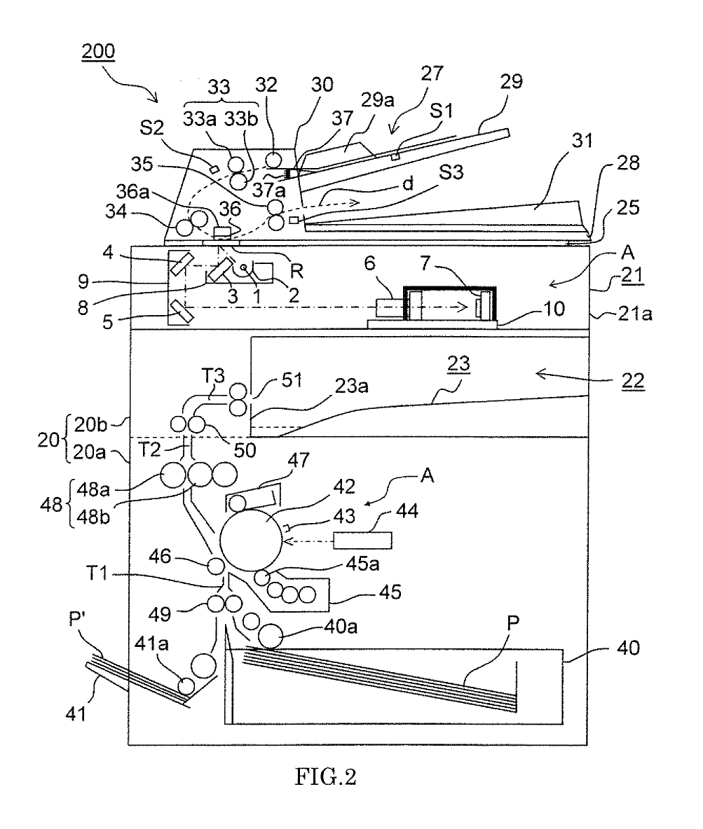

Embodiments will now be described with reference to the drawings. FIG. 1 is an external perspective view of an image forming apparatus according to some embodiments. FIG. 2 is a schematic sectional view showing the internal configuration of the image forming apparatus shown in FIG. 1.

As shown in FIGS. 1 and 2, in some embodiments image forming apparatus 200 may be a digital copier utilizing internal paper ejection type. In some embodiments, a monochrome copier is used as an image forming apparatus 100. Image forming apparatus 100 may include other image forming apparatuses such as a color copier, a monochrome copier, a monochrome printer, color printer, a facsimile machine printers, a multifunction machine, or any other image forming apparatus known in the art. An embodiment may include image forming apparatus 200 having main body housing 20 and upper housing 21 disposed on the top of main body housing 20. In some embodiments, upper housing 21 may include mechanisms for reading the image of a document as an electric signal. Main body housing 20 may be provided with mechanisms for transferring an image to paper on the basis of the electric signal of the read document image. “Paper” as used herein, may include, but is not limited to any material suitable for use in a printer such as paper, overhead projector sheets, etc.

In an embodiment, main body housing 20 may include lower housing 20a and connecting housing 20b. As shown in FIG. 1, some embodiments may include connecting housing 20b located on the top of lower housing 20a and along the left edge of lower housing 20a. Connecting housing 20b may be coupled in some manner to upper housing 21. Some embodiments may include lower housing 20a having a paper feed unit, an image forming unit that forms a toner image on paper, and/or a fixing unit for fixing the toner image on paper. In an embodiment, connecting housing 20b may be provided with a paper ejection unit for conveying and ejecting paper after fixing.

As shown in FIG. 1, in some embodiments just below upper housing 21 and on the right side of connecting housing 20b, an internal paper ejection space 22 may be formed. In some embodiments, an area proximate the internal paper ejection space may be open. For example, as depicted in FIG. 1, the area on the right side and in front of internal paper ejection space 22 may be wide open. In internal paper ejection space 22, paper ejection tray 23 may be provided. In some embodiments, paper ejected in the horizontal direction from the right side of connecting housing 20b may be received by paper ejection tray 23 and may be placed thereon. In some embodiments, an operation panel may be provided proximate the paper injection tray. For example, as depicted in FIG. 1, operation panel 26 may be provided in front of paper ejection tray 23.

In some embodiments, the upper housing of the image forming apparatus may include devices and/or structures utilized to read documents. For example, in some embodiments, documents may be read in multiple manners. For example, documents may be read using a sheet-through manner in which documents are automatically conveyed and read. In some embodiments, documents may be read using a fixed-document manner in which every time a document is read, a portion of the image forming apparatus is opened and closed to replace the document. As shown in FIG. 2, some embodiments may include document platen 25 on the top of upper housing 21. In some embodiments, the document platen may be constructed from, but is not limited to a transparent material such as a transparent glass plate, transparent plastic, or any material known in the art.

As depicted in FIG. 2, some embodiments may include document holder 28 above upper housing 21. Document holder 28 may be supported by a hinge (not shown) fixed to the back of upper housing 21. The hinge may allow the document holder to open and close. In some embodiments, the hinge may be configured to hold the document holder in an open or closed position. In some embodiments, document conveying unit 27 may be mounted on document holder 28. Document conveying unit 27 may convey a document to an image reading position R on document platen 25. Document holder 28 can assume a closed state in which it is closed relative to document platen 25 and a document is read, and an open state in which it is open relative to document platen 25.

When an image forming apparatus is used to read documents in a sheet-through manner documents are automatically conveyed by document conveying unit 27 and read with document holder 28 closed. When documents are read in a fixed-document manner by the image forming apparatus every time a document is read, document holder 28 is opened and closed to replace the document on document platen 25. In some embodiments utilizing the sheet-through manner, an optical system may be provided in upper housing 21. In an embodiment, the optical system may be held in a predetermined position when documents are read. For example, the optical system may not move in some embodiments. In an embodiment utilizing the fixed-document manner, an optical system may move when a document is read.

In some embodiments, a document conveying unit may be used to deliver the paper in a sheet-through manner. As shown in FIG. 2, document conveying unit 27 may include document feed tray 29, document cover 30, and document ejection tray 31. In some embodiments, document feed tray 29 has document guide 29a for placing documents to be supplied in an aligned state. As shown in FIG. 2, document cover 30 may be located over the image reading position R on document platen 25, and document feed tray 29 may project from document cover 30. In some embodiments, document ejection tray 31 may be formed on the side of document cover 30. In an embodiment, the document ejection tray may be coupled to the document holder. For example, as is shown in FIG. 2, document ejection tray 31 may be attached to part of the upper surface of document holder 28. A document conveying path d may be formed from document feed tray 29 through document cover 30 to document ejection tray 31.

In some embodiments, document cover 30 may include a document conveyer. As shown in FIG. 2, the document conveyer may include pickup roller 32, conveying roller pair 33, registration roller pair 34, and ejection roller pair 35, which are arranged along the document conveying path d in the order listed from the upstream side. In some embodiments, conveying roller pair 33 may include feed roller 33a and separation roller 33b. The conveying roller pair may rotate separately and/or in conjunction with each other. For example, when the torque of rotational load is below a predetermined torque, separation roller 33b rotates in the opposite direction from the feed roller 33a. For example, the predetermined torque may be in a range from about 350 gram force per centimeter (hereinafter “gf/cm”) to about 650 gf/cm. In some embodiments, a predetermined torque may be in a range from about 450 gf/cm to about 550 gf/cm. An embodiment may include a predetermined torque in a range from about 475 gf/cm to about 525 gf/cm. For example, in some embodiments the predetermined torque may be about 500 gf/cm. When the torque of rotational load exceeds the predetermined torque, separation roller 33b is rotated by feed roller 33a. For example, in an embodiment, when the torque of the rotational load exceeds 500 gf/cm separation roller 33b is rotated by feed roller 33a.

As depicted in FIG. 2, some embodiments may include white reference plate 36 and document presser 36a positioned between registration roller pair 34 and ejection roller pair 35. In an embodiment, white reference plate 36 may be disposed so as to face the image reading position R on document platen 25. Some embodiments may use white reference plate 36 for shading correction. As shown in FIG. 2, some embodiments may include document presser 36a positioned behind white reference plate 36. Document presser 35a may press white reference plate 36 toward image reading position R. In some embodiments, document conveying path d may curve. For example, as is depicted in FIG. 2, document conveying path d may reverse the direction of a document traveling along the document conveying path between conveying roller pair 33 and image reading position R.

In some embodiments, a sensor may be placed along the document conveying path at appropriate places. A plurality of sensors may be placed along the document conveying path in an embodiment. The sensor or the plurality of sensors may be configured to detect the presence or absence of a document. For example, document detecting sensor S1 is provided in the middle of document feed tray 29, paper feed sensor S2 is provided downstream of conveying roller pair 33, and ejection sensor S3 is provided downstream of ejection roller pair 35.

In such a document conveying unit, documents set on document feed tray 29 may be conveyed sequentially. For example, documents may pass one at a time through document conveying path d, pass over image reading position R, and then be sequentially ejected onto document ejection tray 31 by the document conveyer. The documents ejected onto document ejection tray 31 may be removed by the user with their hand.

When utilizing the document conveying operation in the sheet-through manner, a plurality of documents set face up on document feed tray 29 are pressed against pickup roller 32 at a predetermined pressure by document bearing member 37 urged upward by spring member 37a. In some embodiments, the predetermined pressure used to press the documents against the pickup roller is in a range from about 20 grams force (hereinafter “gf”) to about 500 gf. Document bearing member 37 may apply a predetermined pressure of about 100 gf to about 300 gf. In an embodiment, the predetermined pressure may be in a range from about 150 gf to about 250 gf. For example, in an embodiment, documents on document feed tray 29 are pressed against pickup roller 32 at a pressure of about 200 gf by document bearing member 37. In some embodiments, in response to pressing a copy start button on operation panel 26 (see FIG. 1), a primary feed driver (not shown) may rotationally drive pickup roller 32 and conveying roller pair 33.

In some embodiments, several documents at the top of the stack set on document feed tray 29 may be sent by pickup roller 32 to conveying roller pair 33. Of the several documents sent to conveying roller pair 33, only the uppermost one is separated by separation roller 33b and conveyed to registration roller pair 34 in an embodiment. In some embodiments, after a leading edge of a document is detected by paper feed sensor S2 and the document is conveyed by a predetermined distance, the primary feed driver stops rotationally driving feed roller 33a of conveying roller pair 33 and pickup roller 32, and primary feed is completed. The primarily fed document may be halted with leading edge thereof pressed against the nip of registration roller pair 34 and the front part thereof bent.

A predetermined time after the primary feed, a secondary feed may be started. For example, a secondary feed driver (not shown) may rotationally drive registration roller pair 34. The document may be conveyed by registration roller pair 34 through the image reading position R to ejection roller pair 35 and finally ejected by ejection roller pair 35 onto document ejection tray 31. The ejection sensor S3 detects the trailing edge of the document, thereby detecting the completion of reading the document.

In some embodiments, the ejection sensor S3 may be capable of counting the number of documents after feeding of the documents is complete. If the document detecting sensor S1 detects remaining documents, the remaining documents may be fed in the same manner as above. When passing through the image reading position R, the document may be pressed against document platen 25. For example, during conveyance through the image reading position R the document may be pressed against document platen 25 by white reference plate 36 and document presser 36a, and the image of the document may be read through the image reading position R.

In some embodiments, an image reading unit A may be provided in upper housing 21. The image reading unit may read an image of a document as an electric signal. An embodiment may include various configurations of an image reading unit, having multiple elements. For example, a configuration of an image reading unit is depicted as image reading unit A as shown in FIG. 2. As shown in FIG. 2, upper housing 21 may include lamp 1, reflector 2, first mirror 3, second minor 4, third mirror 5, lens barrel 6, and photoelectric conversion module (for example, a line-type CCD) 7. In some embodiments, additional components may be included in an image reading unit. An embodiment may include lens barrel 6 and photoelectric conversion module 7 disposed on base plate 10. In some embodiments, lamp 1 may be a light source for irradiating the image surface of a document with light. An embodiment may include reflector 2 which efficiently irradiates the image surface of the document with the light from lamp 1. In some embodiments, one or more mirrors may be used to direct the light reflected off of the document. For example, as shown in FIG. 2, the reflected light from the document may be directly received and reflected by first mirror 3. The reflected light from first minor 3 may be received and reflected by second mirror 4. The reflected light from second mirror 4 is received and reflected by third minor 5. In some embodiments, light reflected from the mirrors may be directed to a lens barrel and focused by lenses in the barrel. For example, as shown in FIG. 2, the light reflected from third mirror 5 may be introduced into lens barrel 6 and collected by lenses (not shown) held in lens barrel 6. The light collected by the lenses in lens barrel 6 may be received by photoelectric conversion module 7 and converted into an electric signal. The optical path of reflected light from the document is shown as alternate long and short dash line.

In some embodiments, lamp 1, reflector 2, and first mirror 3 may be integrally fixed to first carriage 8. As shown in FIG. 2, some embodiments include second mirror 4 and third mirror 5 which are integrally fixed to second carriage 9. An embodiment may include first carriage 8 and second carriage 9 which are independent from each other but are capable of reciprocating in conjunction with each other. When the image of a document is read in the sheet-through manner, first carriage 8 may move to just below the image reading position R and is held there, and second carriage 9 may be held in a predetermined position. In some embodiments, this predetermined position may be a position in which the optical path length for the appropriate image formation of the document image on photoelectric conversion module 7 by the lenses in lens barrel 6 can be maintained. In the case of the fixed-document manner, first carriage 8 and second carriage 9 reciprocate (scan) while maintaining a constant optical path length of the document reflection.

In some embodiments, document reflection, i.e., light emitted from lamp 1 and reflected by the image surface of the document, is reflected by the mirrors 3, 4, 5, introduced into the lenses in lens barrel 6, collected by the lenses, and forms an image on photoelectric conversion module 7. Photoelectric conversion is performed in photoelectric conversion module 7, and the document image is read as an electric signal.

As shown in FIG. 2, various mechanisms may be provided in main body housing 20 in order to transfer an image to paper on the basis of the electric signal of the read document image. For example, an embodiment may include a paper feed unit. As depicted in FIG. 2, a paper cassette (e.g., paper feeder) 40 may be disposed in the lower part of lower housing 20a. Various sizes of paper can be loaded in paper cassette 40. In some embodiments, paper cassette 40 can be pulled out from the front. Some embodiments may include paper cassettes which can be accessed from one or more sides (e.g., back, front, and/or the lateral sides). Sheets of paper P loaded in paper cassette 40 are sent out one at a time by pickup roller 40a. As shown in FIG. 2, some embodiments include manual feed tray 41 provided on the left side of the lower part of lower housing 20a. Sheets of paper and/or OHP sheets P′ set on manual feed tray 41 are sent out one at a time by pickup roller 41a.

Some embodiments may include an image forming unit that forms a toner image on paper, and a fixing unit for fixing the toner image on paper. As shown in FIG. 2, main image forming unit B may be disposed in lower housing 20a above paper cassette 40. As depicted in FIG. 2, main image forming unit B may include photosensitive drum 42, charging device 43, laser exposure unit 44, developing device 45, transfer roller 46, and cleaning device 47 disposed proximate photosensitive drum 42. Some embodiments may include a main fixing unit. As shown in FIG. 2, a main fixing unit may include fixing device 48 disposed in lower housing 20a, above transfer roller 46, and just below connecting housing 20b.

In some embodiments, photosensitive drum 42 is made of positively chargeable amorphous silicon. Photosensitive drum 42 may rotate in a clockwise direction at a predetermined circumferential speed when an image forming operation is executed. In some embodiments, the photosensitive drum may rotate in a clockwise direction at a circumferential speed within a range from about 50 mm/second to about 300 mm/second when an image forming operation is executed. In an embodiment, the number of pages, type of paper and/or size of paper may affect the number of prints made per minute. Some embodiments may include setting a predetermined circumferential speed based on the number of prints to be made per minute. For example, the photosensitive drum may rotate in a clockwise direction at a circumferential speed of 107 mm/second when an image forming operation of 20 prints/minute at A4 size paper is executed. In some embodiment, the surface of photosensitive drum 42 may be uniformly charged by corona discharge from charging device 43 to which a high voltage is applied. After the photosensitive drum is charged, laser exposure unit 44 may irradiate the surface of photosensitive drum 42 with a light beam. In some embodiments, irradiating the photosensitive drum may form an electrostatic latent image including portions at a predetermined light potential and portions at a predetermined dark potential. For example, the predetermined light potential may be in a range from about 10V to 100V and the predetermined dark potential from 125V to 600V. In some embodiments, the predetermined light potential may be in a range from about 20V to about 50V and the predetermined dark potential may be in a range from about 250V to about 300V. In some embodiments, laser exposure unit 44 may be directed to irradiate the photosensitive drum based on a document image signal from photoelectric conversion module 7.

In some embodiments, rotating photosensitive drum 42 may move the electrostatic latent image to the developing position. As shown in FIG. 2, developing roller 45a is a component of developing device 45. In some embodiments, the developing roller may be made of stainless steel and may have a stationary magnet therein. In an embodiment, developing roller 45a may be rotatably supported such that there is a predetermined clearance between developing roller 45a and photosensitive drum 42. For example, in an embodiment developing roller 45a may be rotatably supported such that there is a clearance in a range from about 0.05 mm to 0.5 mm between developing roller 45a and photosensitive drum 42. In some embodiments, developing roller 45a may be rotatably supported such that there is a clearance in a range from about 0.1 mm to 0.2 mm between developing roller 45a and photosensitive drum 42. When driven, developing roller 45a may rotate at a circumferential speed of 150 mm/second in the same direction as photosensitive drum 42. In some embodiments, developing device 45 may be tilled with a positively chargeable magnetic toner with, a volume average particle diameter of 9 μm (median diameter measured using a Coulter counter). An embodiment may include a magnetic blade (not shown) which forms a thin toner layer on the surface of developing roller 45a. In some embodiments, a predetermined developing bias voltage may be applied to developing roller 45a. In some embodiments, a developing bias voltage may be in a range from about DC+100V to about DC+500V may be applied to developing roller 45a. For example, in an embodiment, a predetermined developing bias voltage of about DC+290V may be applied to developing roller 45a. When reaching the developing region, toner is caused to take off from the surface of developing roller 45a by the developing bias voltage. The toner may then become attached to the electrostatic latent image on the surface of photosensitive drum 42. Thus, a toner image is formed (developed).

After being sent out from paper cassette 40 (or manual feed tray 41) and reaching registration roller pair 49, paper P (or P′) is sent out upward by registration roller pair 49 in synchronization with the toner image on photosensitive drum 42 approaching transfer roller 46, and is conveyed through a conveying path T1 to the clearance between photosensitive drum 42 and transfer roller 46. The leading edge of the paper P and the leading edge of the toner image pass through the transfer roller 46 at the same time, and most of the toner in the toner image is thereby transferred onto the paper P.

Toner that is not transferred to the paper P but left on the surface of photosensitive drum 42 is removed from photosensitive drum 42 by cleaning device 47. The paper P to which the toner image is transferred is sent to fixing device 48. In some embodiments, fixing device 48 has a fixing roller pair including heating roller 48a and pressing roller 40. The fixing roller pair heats and presses and thereby fixes the developed toner image on the paper P passing through the nip between the rollers. Thus, a fixed transferred image is formed on the paper P.

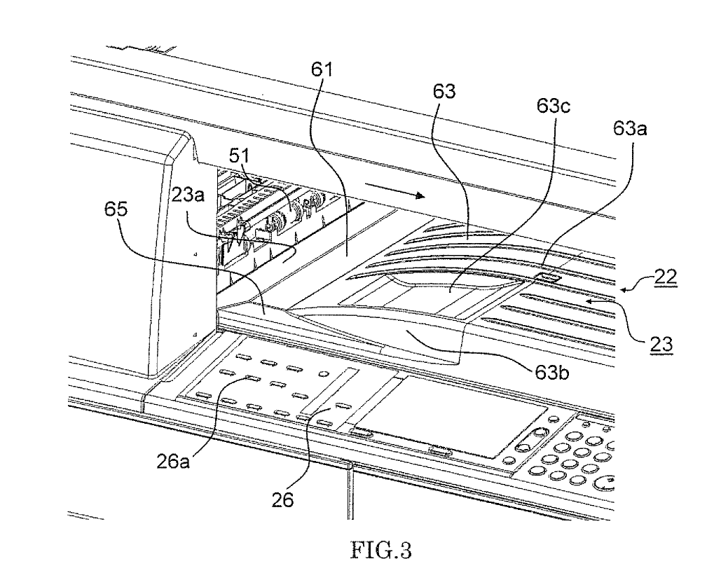

After passing through fixing device 48, the paper P is conveyed along a vertical conveying path T2 into connecting housing 20b. Some embodiments may include conveying roller pair 50 and ejection roller pair 51 in connecting housing 20b. Conveying roller pair 50 may be connected to the vertical conveying path T2. Ejection roller pair 51 may eject the sheet P onto paper ejection tray 23. In some embodiments, after being sent out from conveying roller pair 50, the paper P reaches ejection roller pair 51 through a conveying path T3 and may be ejected by ejection roller pair 51 onto the paper ejection tray 23. As shown in FIG. 3, an embodiment may include paper ejection tray 23 having sloping portion 63. The sloping portion may slope upward in the direction of ejection. Sheets of paper P ejected onto paper ejection tray 23 may slide off due to the slope, and the trailing edges of the sheets may be evened out by coming to rest against back wall 23a (wall on the upstream side in the direction of ejection) 23a.

In some embodiments, a paper ejection tray may be disposed on the bottom of the internal ejection space. As shown in FIG. 1, paper may be ejected from the ejection rollers in the direction of the arrow depicted. An embodiment may include paper ejection tray 23 having flat portion 61 that is substantially horizontal and that is located on the upstream side of the paper ejection tray. Some embodiments may include sloping portion 63 that slopes upward from flat portion 61 in the paper ejection direction. As depicted in FIG. 1, protruding portion 65 may slope upward from flat portion 61 to the front of the apparatus main body. In some embodiments, protruding portion 65 may be positioned such that an upper edge of protruding portion is higher than the top of operation panel 26.

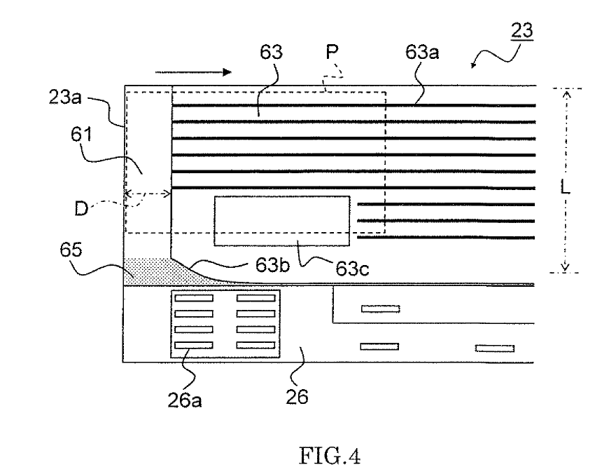

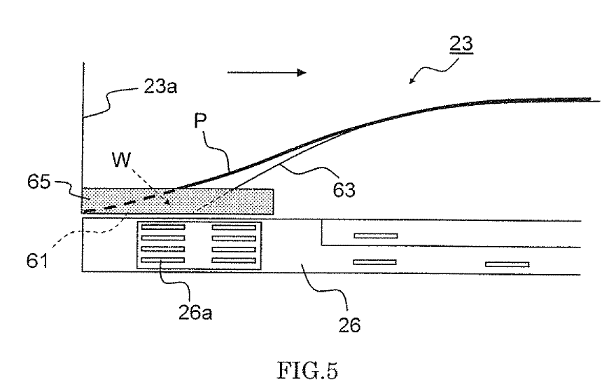

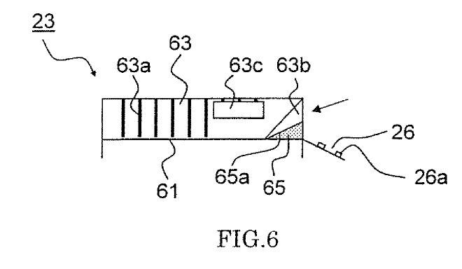

FIG. 3 is an enlarged partial perspective view showing the paper ejection tray of the image forming apparatus of FIG. 1. FIG. 4 is a plan view of the flat portion, the sloping portion, the protruding portion, and the operation panel of FIG. 3. FIG. 5 is a front view of the flat portion, the sloping portion, the protruding portion, and the operation panel of FIG. 4 with paper placed on the paper ejection tray. FIG. 6 is a left side view of the flat portion, the sloping portion, the protruding portion, and the operation panel of FIG. 4.

As shown in FIGS. 3 and 4, an embodiment may include paper ejection tray 23 having substantially horizontal flat portion 61 and sloping portion 63. In some embodiments, flat portion 61 extends from back wall 23a downstream (rightward in the figures) by a predetermined distance D. Sloping portion 63 may slopes upward from flat portion 61 downstream in the direction in which paper is ejected (direction of the arrow). As shown in FIGS. 3, 5, and 6, in some embodiments, flat portion 61 may be disposed at substantially the same height as the top of operation panel 26 having operation buttons 26a.

As shown in FIG. 4, some embodiments may include ribs 63a are formed on sloping portion 63 in the direction of ejection. In some embodiments, utilizing ribs in this manner may reduce an area of contact between the paper P and paper ejection tray 23, so that the leading edge of the ejected paper P can easily move on paper ejection tray 23. As shown in FIG. 4, front end face 63b of the upstream end in the direction of ejection (i.e., the left end in FIG. 4) of sloping portion 63 bends toward flat portion 61 and toward the back of the apparatus main body.

In some embodiments, a depression may be formed proximate and/or in a portion of the sloping portion. For example, as shown in FIG. 4 depression 63c may be formed in front of an upstream part of sloping portion 63. This depression may facilitate holding of paper P of varying sizes. For example, a depression in the sloping portion may facilitate holding paper having a small width, such as A4 paper, placed on the paper ejection tray 23. In the direction perpendicular to the direction of ejection (i.e., the vertical direction in FIG. 4), flat portion 61 may be substantially the same in length as the upstream edge in the direction of ejection of sloping portion 63. As shown in FIG. 5, flat portion 61 and sloping portion 63 form a space W, which facilitates holding of paper P.

As shown in FIGS. 4 to 6, some embodiments may include protruding portion 65 from flat portion 61 to the front of the apparatus main body (downward in FIG. 4). In some embodiments, protruding portion 65 may slope upward. As shown in FIG. 4, protruding portion 65 extends along the bending part of front end face 63b of sloping portion 63. In some embodiments, protruding portion 65 slopes upward from a position within the maximum passing width L of ejected paper P to the front of the apparatus main body shown near the bottom of FIG. 4.

As shown in FIG. 5, when the user inserts their hand into the space W defined by the sheet P, flat portion 61, and sloping portion 63, the user needs to insert their hand over protruding portion 65 to grasp the paper P (see the arrow). When the user pulls out their hand after holding the paper P, the user needs to pull out their hand over protruding portion 65 to take out the paper P from paper ejection tray 23.

Therefore, this configuration encourages the hand to be inserted obliquely downward and pulled out obliquely upward. Since the movement of the user's hand can be guided when taking out the paper P, the hand can be inhibited and/or prevented from touching operation buttons 26a of operation panel 26.

Due to space W depicted in FIG. 5, the user can easily hold the paper P without unnecessarily moving their hand. In addition, when taking out the paper P, the movement of the hand is guided so that the hand can be inhibited and/or prevented from touching the operation panel. This simple configuration facilitates taking out of the paper P, and secures clearance between the hand holding the paper P and operation panel 26. Therefore, when taking out the paper P, the hand can be inhibited and/or prevented from touching operation panel 26 and causing a malfunction.

In an embodiment, protruding portion 65 slopes upward from a position within the maximum paper passing width L to the front of the apparatus main body. Thus, when taking out paper, the hand inserted along protruding portion 65 can be more reliably guided to the space W. This more reliably inhibits and/or prevents the hand from touching the operation panel. In addition, since the inserted hand can be guided close to the paper P by protruding portion 65, the paper P can be taken out more easily. However, protruding portion 65 may be sloped from a position outside (in front of) the maximum paper passing region L.

As shown in FIG. 6, some embodiments may include front end face 63b at an upstream end in the direction of ejection of sloping portion 63 which bends toward flat portion 61 and toward the back of the apparatus main body. As shown in FIG. 6, protruding portion 65 may extend along the bending part of front end face 63b. Therefore, the area of the front face of protruding portion 65 is large, and the hand can easily follow protruding portion 65, and the hand can be guided to the space W more reliably. In addition, due to the increased space into and out of which the hand moves, the hand is more unlikely to touch the operation panel.

In some embodiments, the front face end may include alternate configurations. For example, front end face 63b may be formed along the direction of ejection without bending to the back. In some embodiments, protruding portion 65 may be formed along the direction perpendicular to the direction of ejection without being provided with the extending part. An embodiment may include front end face 63b at the upstream end in the direction of ejection of sloping portion 63 which bends toward flat portion 61 and toward the front of the apparatus main body. The shape and arrangement are not limited to the above embodiment.

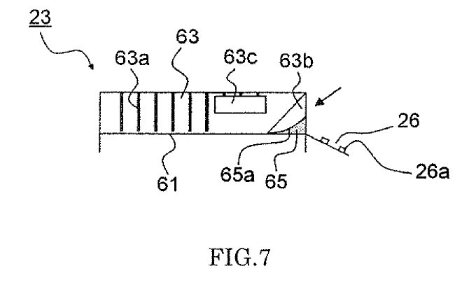

In an embodiment, flat portion 61 is disposed at substantially the same height as the top of operation panel 26. Therefore, the height of the apparatus main body can be restrained. However, flat portion 61 may be lower than the top of operation panel 26. In an embodiment, as shown in FIG. 6, sloping surface 65a of protruding portion 65 is flat. The shape of the protruding portion is not limited, other geometries may be used. For example, as shown in FIG. 7, sloping surface 65a of protruding portion 65 may curve downward. In this case, when taking out the paper P, the hand can be smoothly guided along sloping surface 65a.

An inadvertent touch to operation buttons 26a may cause a malfunction. In some embodiments, operation panel 26 may be a flat touch panel. Reducing the likelihood of an inadvertent touch to the operation panel 26 may allow for various configurations of operation panel 26. In some embodiments, the predetermined length D, the length in the direction perpendicular to the direction of ejection of flat portion 61, the maximum paper passing width L, the height of sloping portion 63, the shape and size of protruding portion 65, and the like can be appropriately set according to the size of paper P. Thus, the configuration of the apparatus main body and the elements thereof may vary.

In the image forming apparatus of an embodiment, a lower housing may include a paper feed unit and an image forming unit; an upper housing may house an image reading unit; a connecting housing couple the lower housing and the upper housing; and paper may be ejected into an internal paper ejection space formed at the side of the connecting housing and between the lower housing and the upper housing. In some embodiments, an image forming apparatus may include a lower housing which houses a paper feed unit and an image forming unit; an image reading unit mounted on a separate supporting frame; and an image reading unit located over the lower housing so that a paper ejection space is formed between the lower housing and the image reading unit.

It is to be understood that the present invention is not intended to be limited to the above-described embodiment, and various changes may be made therein without departing from the spirit of the present invention.

An embodiment may include a paper ejection tray disposed on the bottom of an internal paper ejection space and provided with: a flat portion extending substantially horizontally by a predetermined distance downstream from the upstream end in the direction in which paper is ejected; a sloping portion sloping upward from the flat portion downstream in the direction of ejection; and a protruding portion sloping upward from the flat portion to the front, the top of the protruding portion being higher than the top of the operation panel.

In some embodiments, a paper ejection tray as described may be utilized in conjunction with an image forming apparatus such as a monochrome copier, a color copier, a monochrome printer, a color printer, a facsimile machine, or a multifunctional machine.

In some embodiments, a paper ejection tray may be disposed on the bottom of a paper ejection region. The paper ejection region may be positioned proximate an image forming unit. The paper ejection tray may be positioned on the bottom surface of the paper ejection region. In various embodiments, the paper ejection region may receive paper after image formation. The paper ejection tray in the paper ejection region may be provided with: a flat portion extending substantially horizontally by a predetermined distance downstream from the upstream end in the direction in which paper is ejected; a sloping portion sloping upward from the flat portion downstream in the direction of ejection; and a protruding portion sloping upward from the flat portion to the front, the top of the protruding portion being higher than the top of the operation panel.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

Having thus described in detail embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. An image forming apparatus comprising:
a paper feed unit configured to feed paper;
an image forming unit that forms an image on paper fed from the paper feed unit;
an image reading unit that is disposed over the image forming unit and that reads the image of a document;
a paper ejection space provided between an upper surface disposed beneath the image forming unit and a bottom surface disposed above the image reading unit, wherein at least a front side of the paper ejection space includes an opening that provides for manual accessibility by a user into and toward a backside of the paper ejection space;
a paper ejection tray that is disposed on the bottom surface at the bottom of the paper ejection space and onto which paper after image formation is ejected; and
an operation panel having at least a portion thereof disposed in front of the paper ejection tray along a direction from said backside to said front side, wherein the paper ejection tray has:
a flat portion that extends substantially horizontally by a predetermined distance downstream from a wall on the upstream side in a paper ejection direction;
a sloping portion that slopes upward from the flat portion downstream in the paper ejection direction; and
a protruding portion that slopes upward from the flat portion to the front, the top of the protruding portion being higher than the operation panel.

2. The image forming apparatus according to claim 1, further comprising:
a lower housing in which the paper feed unit and the image forming unit are disposed;
an upper housing in which the image reading unit is disposed; and
a connecting housing that connects the lower housing and the upper housing,
wherein the paper ejection space is provided at the side of the connecting housing and between the lower housing and the upper housing.

3. The image forming apparatus according to claim 2, wherein the paper ejection tray is provided on the top of the lower housing.

4. The image forming apparatus according to claim 1, wherein the protruding portion slopes upward to the front from a position within the maximum passing width of paper ejected onto the paper ejection tray in the direction perpendicular to the paper ejection direction of the flat portion.

5. The image forming apparatus according to claim 1, wherein the protruding portion slopes upward to the front from a position outside the maximum passing width of paper ejected onto the paper ejection tray in the direction perpendicular to the paper ejection direction of the flat portion.

6. The image forming apparatus according to claim 1, wherein the front end face of the upstream part in the paper ejection direction of the sloping portion bends toward the flat portion and toward the back of the apparatus.

7. The image forming apparatus according to claim 1, wherein the front end face of the upstream part in the paper ejection direction of the sloping portion bends toward the flat portion and toward the front of the apparatus.

8. The image forming apparatus according to claim 1, wherein the protruding portion extends along the bending part of the front end face of the sloping portion.

9. The image forming apparatus according to claim 1, wherein the flat portion is disposed at substantially the same height as the top of the operation panel.

10. The image forming apparatus according to claim 1, wherein the flat portion is disposed at a position lower than the top of the operation panel.

11. The image forming apparatus according to claim 1, wherein a sloping surface of the protruding portion curves downward.

12. The image forming apparatus according to claim 1, wherein in the front of the upstream part in the paper ejection direction of the sloping portion, a depression is formed.

13. The image forming apparatus according to claim 1, wherein in the direction perpendicular to the paper ejection direction, the flat portion is substantially the same in length as the upstream edge in the paper ejection direction of the sloping portion.

14. An image forming apparatus comprising:
a paper feed unit configured to feed paper;
an image forming unit that forms an image on paper fed from the paper feed unit;
an image reading unit that is disposed over the image forming unit and that reads the image of a document;
a paper ejection region provided proximate the image forming unit; and
a paper ejection tray that is disposed on the bottom surface at the bottom of the paper ejection region and onto which paper after image formation is ejected comprising:
a flat portion that extends substantially horizontally by a predetermined distance downstream from a wall on the upstream side in a paper ejection direction;
a sloping portion that slopes upward from the flat portion downstream in the paper ejection direction; and
a protruding portion that slopes upward from the flat portion to the front, the top of the protruding portion being higher than an operation panel.

15. The image forming apparatus according to claim 14, wherein the operation panel is disposed in front of the paper ejection tray.

16. The image forming apparatus according to claim 14, further comprising a lower housing in which the paper feed unit and the image forming unit are disposed and wherein the paper ejection space is provided on a top of the lower housing.

17. The image forming apparatus according to claim 14, wherein the protruding portion slopes upward to the front from a position within the maximum passing width of paper ejected onto the paper ejection tray in the direction perpendicular to the paper ejection direction of the flat portion.
